(19) United States
(12) Patent Application Publication
(10) Pub. No.: US 2015/0187134 A1
(43) Pub. Date: Jul. 2, 2015

(54) ARTICULATED CHARACTER FABRICATION

(71) Applicants: PRESIDENT AND FELLOWS OF HARVARD COLLEGE, Cambridge, MA (US); TECHNICAL UNIVERSITY BERLIN, Berlin (DE); CORNELL UNIVERSITY, Ithaca, NY (US)

(72) Inventors: Moritz Niklaus Baecher, Cambridge, MA (US); Bernd Bickel, Zurich (CH); Doug L. James, Ithaca, NY (US); Hanspeter Pfister, Arlington, MA (US)

(73) Assignees: PRESIDENT AND FELLOWS OF HARVARD COLLEGE, Cambridge, MA (US); TECHNICAL UNIVERSITY BERLIN, Berlin (DE); CORNELL UNIVERSITY, Ithaca, NY (US)

(21) Appl. No.: 14/414,150

(22) PCT Filed: Jul. 10, 2013
(86) PCT No.: PCT/US2013/049853

§ 371 Date: Jan. 12, 2015

Related U.S. Application Data
(60) Provisional application No. 61/669,741, filed on Jul. 10, 2012.

(51) Int. Cl. G06T 17/10; G06T 15/08

(52) U.S. Cl. CPC G06T 17/10; G06T 15/08; G06T 2219/012

(57) ABSTRACT

Fabrication of a posable physical embodiment from an articulated deformable model is made possible by first transforming a deformable surface volumetric model to a segmented, rigid volume model including identifying a plurality of rigid, linked segments. The rigid volume model approximates the deformable surface volumetric model. Linkage structures (i.e., hinges, ball joints) coupling pairs of the rigid, linked segments are then automatically determined.

### CROSS REFERENCE TO RELATED APPLICATION

This application claims priority to U.S. Provisional Application No. 61/669,741 filed on Jul. 10, 2012, the contents of which are hereby incorporated by reference in its entirety.

### STATEMENT AS TO FEDERALLY FUNDED RESEARCH

This invention was made with government support under PO1 AG07916 awarded by National Science Foundation. The government has certain rights in the invention.

### BACKGROUND

This invention relates to fabrication of articulated models.

Articulated deformable models, are used in a broad range of computer graphics applications. An example of an articulated deformable model is a skinned character model for use in computer animation. Such a model is generally created by skilled artists who define both the appearance of the character and weighted associations between a hierarchical set of links (i.e., a rig) and groups of vertices on the character's mesh (i.e., a skin). In some examples, content creation systems (e.g., SPORE) allow even naïve users to create sophisticated skinned character models.

In other applications, computer models of solid objects (“volumetric models”), are manipulated using computer aided design (CAD) software applications, such as SolidWorks® or Pro/Engineer®. In some examples, the object represented by a volumetric model can include an assembly of multiple parts, and parts may be linked by joints (e.g., hinges, ball joints) designed using the software application.

With the advent of additive manufacturing (i.e., 3D printing), it is possible for a layperson to fabricate three dimensional physical embodiments of rigid parts which are represented in software models, for example, parts of an assembly designed using a CAD application. It is also possible using current techniques to fabricate physical embodiment of a static pose of a character represented by an articulated deformable model.

### SUMMARY

In one general aspect, fabrication of a posable physical embodiment from an articulated deformable model is made possible by first transforming a deformable surface volumetric model to a segmented, rigid volume model including identifying a plurality of rigid, linked segments. The rigid volume model approximates the deformable surface volumetric model. Linkage structures (i.e., hinges, ball joints) coupling pairs of the rigid, linked segments are then automatically determined. This automated determination of at least some of the linkage structures takes into account one or more physical constraints. Data suitable for controlling automated generation of one or more physical embodiments of the rigid volume model is then stored. In some examples, this data is then used to fabricate multi-segment physical embodiment, for example, using a three-dimensional printer.

One or more aspects address the technical problem of forming a physical embodiment of a model that is specified in a manner that represents a deformable surface where the fabrication technology (e.g., 3D printing) provides a way for making rigid parts. Generally, the approach may include transforming the deformable surface model to include rigid parts that can be fabricated, and preferably to include linkage structures that are fabricated to permit motion that approximates allowable motion represented in the model.

Other features and advantages of the invention are apparent from the following description, and from the claims.

### DESCRIPTION OF DRAWINGS

FIG. 1 is a block diagram of an articulated model fabrication system.

FIG. 2 is a simple articulated deformable model.

FIG. 3 is a segmented, rigid-volume model.

FIG. 4 is a segmented, rigid-volume model with joint positions and orientations.

FIG. 5 is a segmented, rigid-volume model including ball and socket joints.

### DESCRIPTION

### 1 Overview

While it is possible to fabricate a three dimensional physical embodiment of an articulated deformable model in a static pose, there still remains a need for a system capable of fabricating a posable three dimensional (3D) physical embodiment of an articulated deformable model. Furthermore, there is a need for such a system to be capable of fabricating a posable three dimensional physical embodiment of a deformable model that is structurally sound while maintaining as much of the articulation of the articulated deformable model as possible.

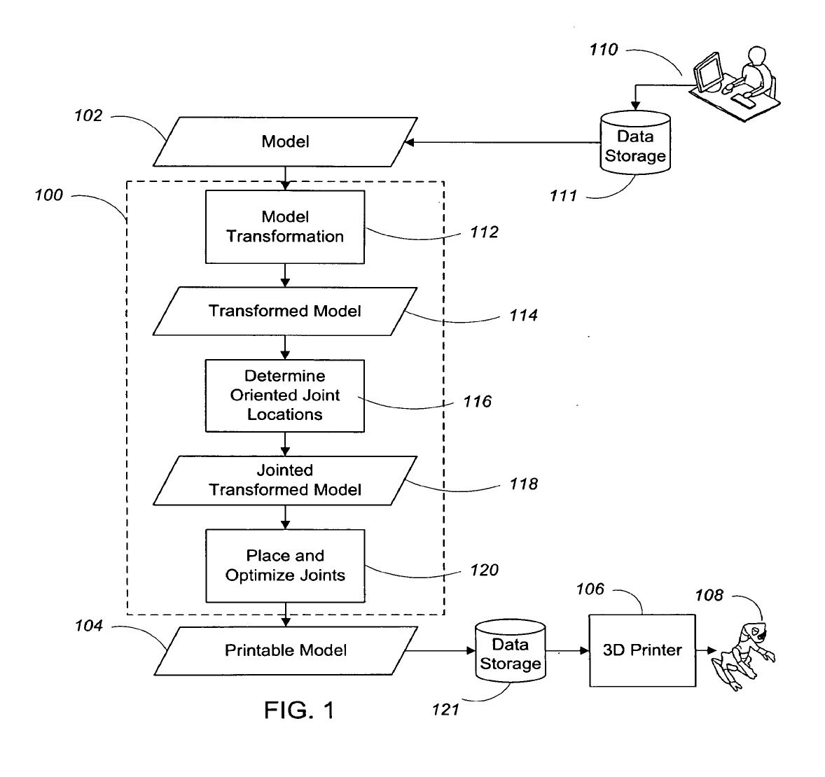

Referring to FIG. 1, a system 100 for fabricating a posable three-dimensional physical embodiment 108 of an articulated deformable model receives a model 102 as input and forms a printable model 104 which includes data suitable for causing a 3D printer 106 to fabricate the posable three-dimensional physical embodiment 108 of the model 102.

### 1.1 Model

In general, the model 102 is designed by an artist or engineer 110 using computer software that is capable of generating volumetric models such as Autodesk® Maya®. The model is stored on a data storage device 111 such as a hard drive of a computer. In some examples, the model 102 is a complex volumetric model such as deformable skinned volumetric model (e.g., a skinned character). Such a model has an input geometry which is specified as a semi-organized set of oriented face tuples f∈F whose components index into a set of vertices v∈V. In some examples, the skinned character also has its articulation behavior specified by a skinning model (e.g., a linear blend skinning (LBS) model) wherein each vertex, i in the set of vertices, V is weighted to a link, l∈L, by a non-negative skinning weight, wᵢₗ. The linear blend skinning model allows deformation of vertex positions by time-varying link transforms, Tₗ, according to the following equation:

$${v}_{i}^{′} = {\sum }_{l} {w}_{il} {T}_{l} {v}_{i}$$

In some examples, the set of link correspondences, L, has a tree structured connectivity defined by a function, P, which maps every link l∈L to a unique parent, P(l), with the root of the tree structure defined as a root node.

### 1.2 Model Transformation

The model 102 is passed to a model transformation module 112 which analyzes the skinning weights and their link correspondences to transform the model 102 to a segmented, rigid-volume model 114. In some examples, the model transformation module 112 determines the individual segments of the model 102 by analyzing the skinning weights of the vertices included in the model 102. The analysis of the skinning weights leverages the fact that the link correspondence P is implicitly encoded into the skinning weights. For example, a given vertex which is located at a midpoint of a given link will have a high skinning weight value for the given link and lower skinning weight values for other links in the model 102. Similarly, vertices which are located further from the midpoint of a given link have lower weight values for the given link. As vertices approach a transition between links in the model, the skinning weights begin to distribute between the links which form the transition.

Using this information, the model transformation module 112 analyzes each vertex included in the model to determine which link each vertex is most strongly associated with (i.e., which link has the greatest skinning weight for the vertex). For each vertex, the weight for the link with the greatest skinning weight value is set to a maximal skinning weight value (e.g., 1.0) and the weights for the other links are set to a minimal weight value (e.g., 0.0). In this way, the deformable skin of the model 102 is transformed into the transformed model 114 which includes number of linked, rigid volume segments.

### 1.3 Joint Location and Orientation

The transformed model 114 is passed to a joint location and orientation module 116 which derives a filtered set of oriented joint locations that include orientation vectors and the joint's rotation centers from the transformed model 114.

A first step in identifying joint locations is to identify areas of transition between two segments of the transformed model 114. This can be done by identifying all unique edges (V,F) which include a first end vertex j with a maximal skinning weight value for a first link lⱼ and a second end vertex k with a maximal skinning weight for a second link lₖ, where lⱼ and lₖ are different links (i.e., lⱼ≠lₖ). Thus, an edge which includes end vertices spanning two links is considered to span a joint transition and is referred to as a transition edge.

The set of transition edges is then partitioned with respect to matching ordered link-pairs (m,o) as follows:

$${⋃}_{( m , o )} \{ \{ j , k \} \vert A ( \{ j , k \} ) \}$$

where A:=((lⱼ=m) [symbol] (lₖ=o)) [symbol] ((lₖ=m) [symbol] (lⱼ=o)) and where link m is closer (or equal distance) to the root node than link o.

The ordered link pairs (m, o) are pairs of links that are known to connect to one another, the connection between each pair of links representing a transition. In general, multiple edges will span each transition represented by the ordered link pairs. The partitioning operation acts to group all edges which span a transition represented by a given link pair together.

A transition point, pⱼₖ, is then computed for each edge associated with each link pair (m,o) of the ordered link pairs as follows:

$$\frac{{w}_{j , {l}_{j}}}{{w}_{j , {l}_{j}} + {w}_{k , {l}_{k}}} {v}_{j} + \frac{{w}_{k , {l}_{k}}}{{w}_{j , {l}_{j}} + {w}_{k , {l}_{k}}} {v}_{k}$$

with normalized weights w_{j,l}_{ⱼ} and w_{k,l}_{ₖ}.

Each transition is then linearly approximated by running Principal Component Analysis on each of the transition points, resulting a mean point p^{(m,o)} and principal components e_{λ}_{₁}, e_{λ}_{₂}, and e_{λ}_{₃}, sorted by their respective variances λ₁≦λ₂≦λ₃. The mean point is considered to be the transition center and the vector n^{(m,o)}=se_{λ}_{₁} is considered to be the transition's orientation. The s variable is set to ±1 based on the direction of the (m, o) transition as defined by the hierarchical structure in P.

In some examples, the oriented joint locations are graphically represented on a computer implemented user interface as a planar disk with its center placed at the transition center and it's orientation defined by the transition orientation vector.

In some examples, the determined oriented joints do not fall entirely within the transformed model 114. Such joints are identified and eliminated.

### 1.4 Joint Placement and Optimization

The transformed model with joint locations 118 is passed to the joint placement and optimization module 120 which places mechanical joint structures into the segmented, rigid volume model at the oriented joint locations. The mechanical joint structures are then optimized for maximum joint articulation and strength.

Some examples of mechanical joints which are placed into the model 118 are ball and socket joints or hinge joints. The physical properties of the joints can be controlled using parameters. For example, to minimize interference of the joints with the character's overall appearance, joint parameters can be limited such that the sockets for the joints are guaranteed to be safely embedded in the model. The size of the joints is also limited such that the joints are not too close together, thus preventing fusion of the joint parts during manufacturing.

In some examples, given a joint design, the critical areas where a joint is likely to break are identified. The parameters related to the joint's dimensions can then be estimated such that the smallest of those critical areas is maximized. One way of determining the critical areas is to use civil engineering techniques to analyze the stress distribution within a joint design under a set of typical loading scenarios. For example, an average stress across a given cross-section, A, is given by the force per area σ=F/A, where F is the residual load. If a local stress level is too high, a joint design may be susceptible to breakage. To prevent breakage, designers adjust the joint design such that a corresponding critical area is increased. Similarly, the joint designs which are placed in the model 118 are designed to maximize a minimal area of a number (e.g., three) of critical cross sectional areas. In this way, the structural integrity of the joint is optimized. In some examples, different types of joint designs with different stress distributions (e.g., different numbers of critical cross sectional areas) under typical loading scenarios can be optimized in a similar fashion.

Some parameters of the joints can be specified by a designer while others are automatically determined. In some examples, a range of motion of a joint can be adjusted to optimize the structural integrity of a joint. In some examples, a range of motion of a joint is specified by a designer and in other examples the range of motion is automatically determined.

In some examples, potential joint placements are impractical due to joints being too closely spaced. For example, two joints which are very closely spaced may result in overlapping joints or joints which are so small that they are structurally weak. Joints which are too closely spaced may also limit each other's range of motion. The joint placement and optimization module 120 includes a joint removal procedure to resolve such joint placement conflicts while maintaining as much of the original model's articulation as possible while keeping the rotation centers of the joints fixed. In some examples, joint placement conflicts are solved by repeatedly reducing the size of the largest (i.e., strongest) joint until either all of the joints fit or one of the joints becomes too small for fabrication.

In some examples, mechanical joints are placed at the oriented joint locations, with the center of the mechanical joints located at a medial axis of the model 118.

In some examples, the joints are configured with a friction mechanism such that the joints can retain their positions when posed. For example, a ball and socket joint can be 3D printed with small, calibrated friction bumps on the ball portion and corresponding small, calibrated recesses in the socket portion. This allows the friction mechanism to be 3D printed without fusing the ball and socket portions.

In some examples, the joints are placed into model 118 using constructive solid geometry (CSG) techniques which effectively carve the joint structures out of the model 118.

### 1.5 Fabrication

The output of the joint placement and optimization module 120 is a data representation of an articulated model 104 which is passed out of the system 100. The data representation of the articulated model 104 is passed to a data storage 121 and can then be passed to a 3D printer 106 which fabricates posable three dimensional physical instance 108 of an articulated deformable model.

### 2 Applications

One interesting application for the system described above is the fabrication of posable embodiments of computer generated characters such as video game characters. For example, an animation software suite such as Maya® can include a 3D print button which causes a 3D printer to print a posable three dimensional physical embodiment of an articulated deformable model which has been designed using the software suite.

However, the range of applications for such a system is broader that the fabrication of video game characters. For example the placement and optimization of joints in mechanical designs such as those produced in a computer aided drafting environment can be challenging. Automatic joint placement and optimization can streamline this process, leading to more rapid development of jointed mechanical designs.

Furthermore, the placement of joints in designs for 3D printing has been a difficult task up to this point because there has been no way to build friction into the joints. Thus, printed joints such as ball and socket joints have not been able to maintain their positions. The friction mechanism described herein allows for the joints to maintain their positions.

### 3 Simple Example

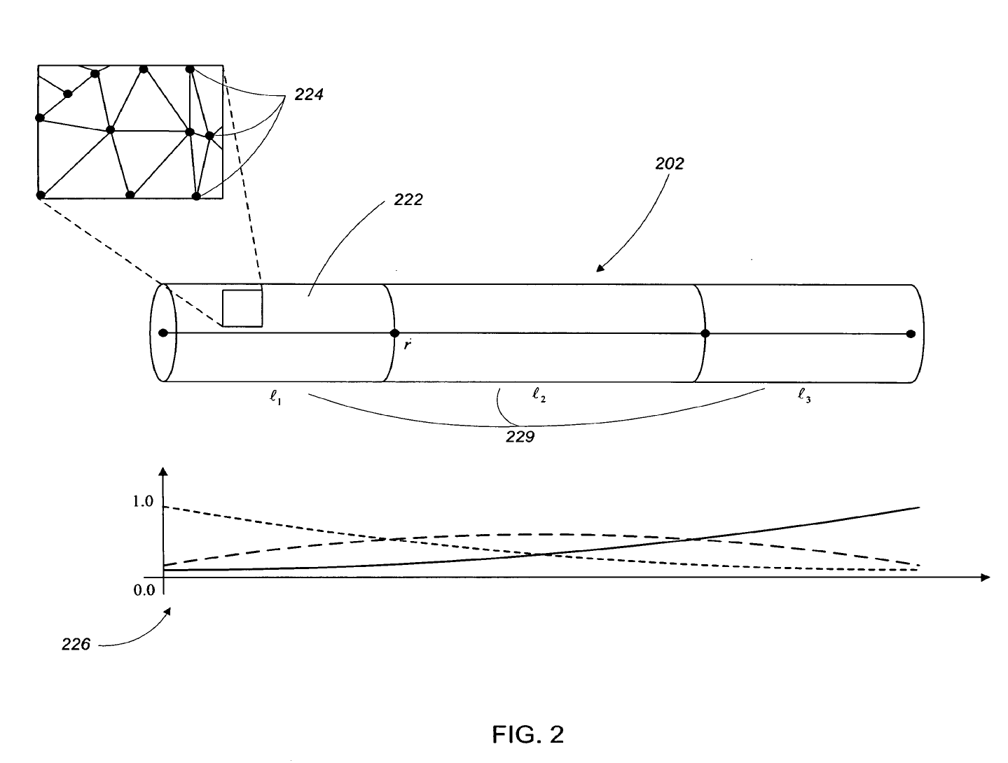

Referring to FIG. 2, a simple cylindrical deformable skinned volumetric model 202 includes a number of links 229 surrounded by a deformable skin 222. The deformable skin 222 includes a number of vertices 224. Each vertex 224 included in the deformable skin 222 includes a skinning weight corresponding to each of the links l₁, l₂, l₃ 229 (i.e., three skinning weights per vertex). The trend of the skinning weights corresponding to each of the links while traversing the model is illustrated in the table 226 below the model 202. It is noted that the skinning weights of the vertices 224 at the center of a given link 229 have a greatest value for the given link 229, indicating that the vertices 224 at the center of the link are almost entirely affected by transformations of the given link with very little influence from the other links. It is also noted that the skinning weights near the transition from one link 229 to the next intersect, indicating that the vertices at the transition point are equally affected by transformations of each of the links 229 involved in the transition.

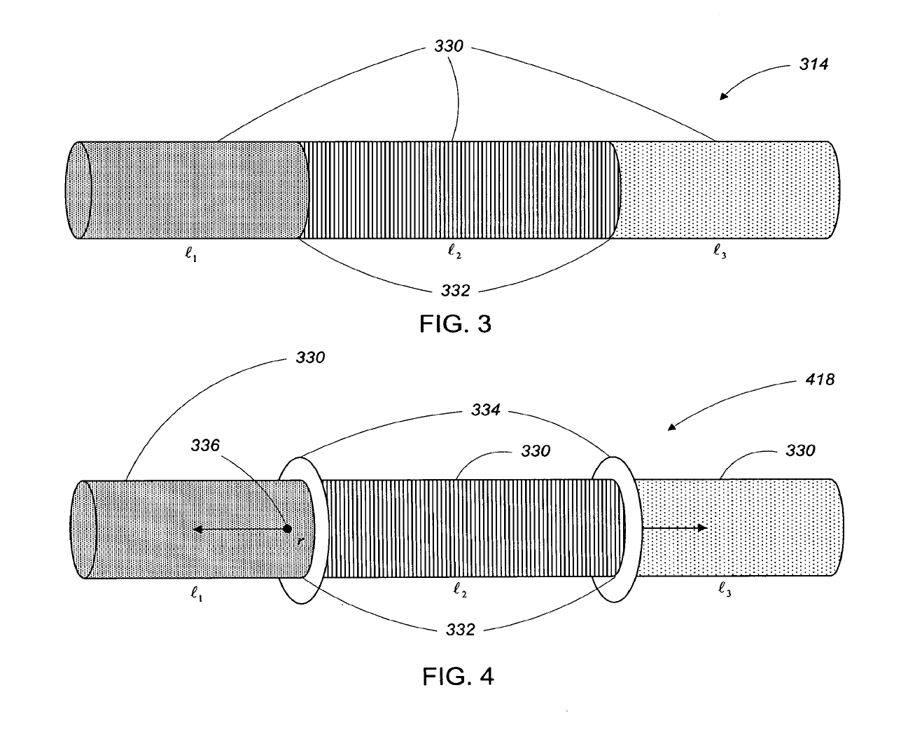

Referring to FIG. 3, as is described above, the model transformation module (FIG. 1, element 112) uses the information included in the skinning weights to segment the deformable skinned volumetric model 202 of FIG. 2 into a rigid volume solid model 214 (as is described above). The rigid volume solid model 214 includes three segments 330, each associated with one of the links 329. Transitions 332 exist at the intersections of the segments 330.

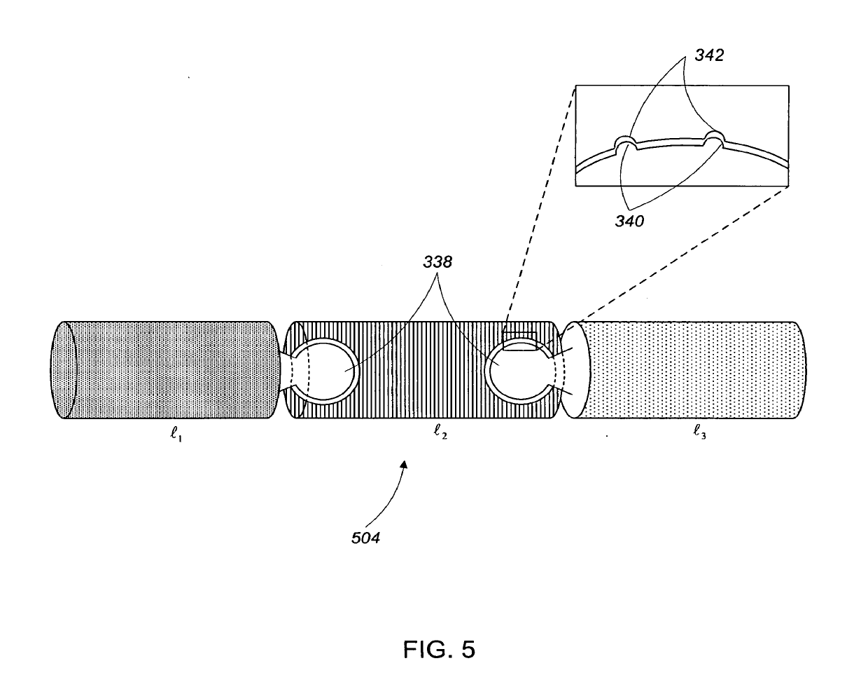

Referring to FIG. 4, the joint location and orientation module (FIG. 1, element 116) determines (as is described above) the exact transition points between the segments 332 and inserts oriented planar disks 334 at the determined transition points 332. In general, the planar disks 334 are oriented such that they face away from the root node 336 of the connectivity tree, P. The planar disks 334 indicate the future location and the orientation of the joints of the model 214.

Referring to FIG. 5, the joint placement and optimization module 120 generates a data representation of an articulated model 104 which includes two ball joints 338 which are placed based on the location and orientation of the planar disks 334 shown in FIG. 4 and are optimized for structural integrity. Note the close-up in FIG. 4 of the ball and socket illustrates one example of a friction mechanism which makes the joints posable. In particular, a number of calibrated friction bumps 340 are included on the ball portion of the joint 338 and a number of corresponding calibrated recesses 342 are included on the surface of the socket portion of the joint 338. As the joint 338 is articulated, the bumps 340 are either fixed into the recesses 342 or pressing against the inner surface of the socket portion of the joint 338.

### 4 Alternative and Optional Features

The description above includes a description of the input model 102 being in the form of an articulated deformable model. However, it should be understood that a variety of other forms of input can be used.

As a first example, it is not necessary that the links (rig) of the original model be provided. Indeed, such links are not in general physically significant and may fall outside the skin of the model. Other models may provide a representation of allowable transformations (poses, morphs) of a surface of an object, and these allowable transformations can be used to identify parts of the surface that are mapped to rigid segments. One way of doing this is to infer a linkage structure give the surface information, and then apply the method described above.

In some examples, the input is not a model, but a sequence of poses of the model, for example, representing a cycle of a mode (or multiple modes) of motion of the object. For example, a “walk cycle” of an animated object (e.g., a sequence of snapshots of the model) can be used as the input. As above, such a cycle can be used to identify the segments, which will ultimately be fabricated as rigid parts. In some examples, rather than a model, the snapshots may be images of a physical object (e.g., a person).

In some examples, the input is not a deformable model, but rather is a model that includes a number of rigid parts, but lacks a specification of the linkage structures that appropriately link the parts. For example, an assembly may be designed in a CAD application (e.g., Solidworks), and a representation of allowable or desired ranges of motion between linked parts is specified (e.g., in a graphical and/or numerical data form) by the designer. Such an assembly does not have to represent a character at all, and can represent a functional assembly. Then, as described above in the context of rigid segments of the character model, linkage structures (e.g., ball joints, hinges) are automatically designed and inserted between the parts to allow the desired motion. Then the fully (or partially) assembled physical embodiment can be printed as described above.

In some examples, the output does not simply represent a set of rigid linked segments. For example, 3D printing may support printing of a flexible surface over rigid structure and such a flexible surface can act as the flexible skin of a character. The techniques described above can be adapted to automatically design the linked rigid segments over which a flexible skin is printed.

### 5 Implementations

Systems that implement the techniques described above can be implemented in software, in firmware, in digital electronic circuitry, or in computer hardware, or in combinations of them. The system can include a computer program product tangibly embodied in a machine-readable storage device for execution by a programmable processor, and method steps can be performed by a programmable processor executing a program of instructions to perform functions by operating on input data and generating output. The system can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits). It should also be understood that the output of procedures described above (e.g., printable model 104) may be stored on a machine-readable medium and may include data (e.g., instructions) that impart functionality to a 3D printer. It is to be understood that the foregoing description is intended to illustrate and not to limit the scope of the invention, which is defined by the scope of the appended claims. Other embodiments are within the scope of the following claims.

1. A method for generating an articulated model comprising:
transforming a deformable surface volumetric model to a segmented, rigid volume model including identifying a plurality of rigid, linked segments, the rigid volume model approximating the deformable surface volumetric model;
automatically determining linkage structures coupling pairs of the one or more rigid, linked segments, wherein automatically determining the linkage structures includes determining the linkage structures at interfaces between the pairs to satisfy one or more physical constraints; and
storing data for controlling automated generation of one or more physical embodiments of the rigid volume model.

2. The method of claim 1 wherein the deformable surface volumetric model includes a skinned mesh model which includes a plurality of weighting values relating a plurality of links to a plurality of mesh vertices, and transforming the deformable surface volumetric model to a segmented, rigid volume model is based on the plurality of weighting values.

3. The method of claim 1 wherein the linkage structures include mechanical joints.

4. The method of claim 3 wherein the mechanical joints include ball and socket joints.

5. The method of claim 3 wherein the mechanical joints include hinge joints.

6. The method of claim 1 wherein the one or more physical constraints includes constraints on the range of motion of one or more of the linkage structures.

7. The method of claim 1 wherein the one or more physical constraints includes constraints on the geometry of one or more of the linkage structures, the constraints configured to optimize the structural integrity of the linkage structure.

8. The method of claim 7 wherein the linkage structures include one or more three dimensional printable surfaces that are configured to maintain a position of the linkage structure using friction.

9. The method of claim 1 further comprising generating the one or more physical embodiments of the rigid volume model.

10. The method of claim 8 wherein generating the physical embodiments includes three dimensional printing.

11. Software embodied on a non-transitory machine-readable medium comprising instructions for causing a data processing system to perform all the steps of claim 1.

12. (canceled)

13. A system for generating an articulated character configured to perform all the steps of claim 1.
